(19) United States
(12) Patent Application Publication
(10) Pub. No.: US 2010/0014275 A1
(43) Pub. Date: Jan. 21, 2010

(54) End cap attachment for chemiluminescent light sticks

(76) Inventor: Earl Cranor, Longmeadow, MA (US)

Correspondence Address: MCHALE & SLAVIN, P.A., 2855 PGA BLVD, PALM BEACH GARDENS, FL, 33410, US

(21) Appl. No.: 12/176,834

(22) Filed: Jul. 21, 2008

(51) Int. Cl. F21K 2/00

(52) U.S. Cl. 362/34

(57) ABSTRACT

End caps for chemiluminescent light sticks. The end caps can be of a numerous styles and materials for coupling to a common light stick body. The end caps can be installed either during the manufacturing stage allowing manufacturer efficiencies or for installation by the consumer such as in a kit. The end caps allow use of a common light stick that may include the chemical light components in sealed containers wherein the container includes a receptacle for securement of the end cap; or in an unsealed container wherein the end cap provides the sealing mechanism for the chemicals. The end caps can be made from most any material providing the manufacturer with the ability to produce a large variety of attachment mechanisms while decreasing the cost of light stick production.

### FIELD OF THE INVENTION

This invention relates to the field of chemiluminescent illumination devices and, more particularly, to the use of independent end cap attachment.

### BACKGROUND OF THE INVENTION

Chemiluminescent illumination devices are non-incandescent products which produce light from a chemical mixture. The basic chemiluminescent process produces light when two chemical solutions are combined. The solutions may be combined and frozen to prevent activation or can be kept physically separated prior to activation. Physical separation typically consists of a sealed frangible glass vial containing a first solution that is placed within a second solution, both of which are housed in a sealed flexible vessel. When the vessel is flexed, the glass vial is ruptured thereby releasing the vial solution which admixes wherein the reaction produces light.

The chemical solutions are generally referred to as the “oxalate” component and the “activator” component. A typical oxalate component consists of Dibutyl Phthalate, CPPO and CBPEA. A typical activator solution contains Dimethyl Phthalate, T-butyl alcohol, 90% aq. Hydrogen Peroxide and Sodium Salicylate. While the materials are non-toxic, the use of dye for coloring may cause staining. Further, the use of light sticks that rely upon the rupturing of a glass vial for activation can pose a hazard if the glass is exposed.

Numerous patents exist that disclose improvements in the oxalate and activators, such patents extending the illumination properties of chemiluminescent devices. The unique lighting effects generated from chemiluminescent lighting devices are enhanced by the inherent optical properties of the containing vessel and the coloring. Some dyes or coloring agents can be used not only as color filters but as fluorescers. A fluorescent dye functions by converting light of one wavelength to another wavelength.

The use of a dye and/or fluoresecer in the vessel casing is also well known, being first disclosed in U.S. Pat. No. 3,584,211 which sets forth a vessel casing for use with chemiluminescent light wherein the visible color of the light emission can be varied by using colored plastic. If the housing breaks open, there is always a danger that material from the inner container will itself be dispensed along with the liquid.

U.S. Pat. No. 5,190,366 discloses a multi-colored chemiluminescent fishing lure formed from a connector body having a plurality of color tubes in a predetermined angular relationship. Attachment to the light sticks is by a receptacle device.

U.S. Pat. No. 4,800,670 discloses a Fishing lure having a chemiluminescnet capsule therein. Various embodiments disclose the use of light stick holders that allow attachment to a fishing line by use of an aperture. U.S. Pat. No. 6,226,917 discloses a fishing lure having end caps that secure to chemiluminescent light sticks. The end caps frictionally engage the outer surface of the light stick and require tie lines to prevent end caps from being pulled off the light stick.

U.S. Pat. No. 5,531,418 a chemiluminescent light stick having a body element formed with one end capable of securing to a fishing line. The light stick is formed for a particular purpose and requires a unique tying arrangement that works well in the fishing environment.

U.S. Pat. No. 6,840,648 discloses a connector to secure to ends of a light stick together. The closed loop allows the light stick to function as a novelty necklace or bracelet.

Another example of a connector used for shaping a light stick is found in U.S. Pat. No. 4,317,337 which teaches the use of clap for holding the opposing ends of a light stick in close proximity.

While the chemiluminescent lighting devices have many advantages, the separation of the chemical components before use and the need to utilize a type of material that is chemically resistant to the components, limit the type of vessel materials to polyethylene, polypropylene and the like plastic, all of which limit the configurations of the light stick typically to a tubular shape.

In view of the prior art, it is noticed that conventional light sticks are made for a particular purpose. For instance a light stick extruded for use in attachment to fishing line may not work in an emergency situation where the light stick make need to be hooked over a line substantially larger than a fishing line. This is an added expense to the manufacturer who needs to carry various product lines to meet the needs of different consumers.

What is needed in the art is way of attaching end caps either during or after the manufacturing process that allows the use of a light stick in a variety of applications.

### SUMMARY OF THE INVENTION

An end cap coupling for use with light sticks to allow a commonality of light stick bodies with a multitude of end caps shapes and materials. The end cap of the instant invention is preferably formed from barbs but may also employ a screw thread for purposes of obtaining a sealed end cap. The requirement being that the barb or thread has ease of assembly but capable of resisting a pull out of 20 lbs or greater.

An objective of the instant invention is to teach the use of separate end caps that can be attached to the light stick at a manufacturing stage or by the consumer, the separate end caps allowing for a commonality of light stick design with the variety of coupling styles demanded by the consumer.

Still another objective of the instant invention is to disclose a use of an end cap that can be changed to meet a particular application.

Still another objective of the instant invention is to reduce the cost of manufacturing by providing a commonality of light sticks with various end cap attachments.

Still another objective of the instant invention is to disclose various end cap attachments capable of preventing premature separation.

Still another objective of the instant invention is to disclose a light stick housing that can be reused by replacement of the chemicals when needed.

Yet another objective of the instant invention is to teach the use of kit allowing the consumer to adapt a light stick to a particular application.

Still another objective of the instant invention is to provide a convenient means for recycling of chemiluminescent devices by removal of the chemical materials before recycling and/or the reuse of the end cap and vessel container.

Yet still another objective of the instant invention is to provide a kit wherein the consumer may modify a light stick for a particular purpose as the situation arises.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a cross sectional side view of a light stick having a sealed vessel casing cavity and one end cap;

FIG. 2 is a cross sectional side view of a light stick with an unsealed vessel casing cavity and one end cap;

FIG. 3 is a cross sectional side view of a light stick having a sealed vessel casing cavity with two end caps;

FIG. 4 is a side view of a full thread end cap;

FIG. 5 is a side view of a partial thread end cap;

FIG. 6 is a side view of an end cap with multiple barbs; and

FIG. 7 is a side view of an end cap with a single barb.

### DETAILED DESCRIPTION OF THE INVENTION

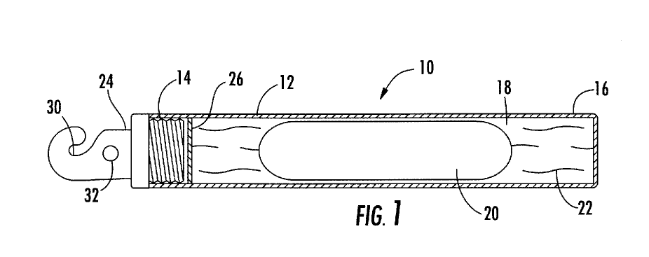

Referring now to FIG. 1, set forth is a light stick formed from a vessel casing 10 having a translucent continuous side wall 12 with a first end 14 and second end 16 forming a cavity 18 therebetween. The cavity is receives chemiluminescent materials, namely an activator 20 and an oxalate 22. In this embodiment a single end cap 24 is removably inserted into a portion of the vessel casing aperture formed along the first end 14. Further to this embodiment, the vessel casing is sealed by the second end 16 and an end wall 26 adjacent the first end so as to allow the end cap 24 to be shipped without an end cap or otherwise add the end cap with a connector means needed for a particular situation. It should be noted that the connector means may be of most any configuration, FIG. 1 illustrating a hook 30 with pass thru aperture 32 as the connector means. This arrangement of a hook is well known and allows for quick attachment to most any object whereas the pass thru aperture can receive a line for secondary securement.

Referring now to FIG. 2, set forth is an having an unsealed vessel casing 40 formed from a translucent continuous side wall 42 having a first end 44 and second end 46 defining a vessel casing aperture 48. The vessel casing aperture illustrates a first frangible ampoule containing an oxalate 50 and a second frangible ampoule containing an activator 62. The second end 46 is sealed while the first end 44 is an opening to the vessel casing. The end cap 54 has a lower portion 56 having a plurality of barbs 58 which are constructed and arranged to allow ease of insertion into the open end of the aperture 40 end. Frictional engagement along the inner surface 60 of the vessel casing provides a tight seal that prevents loss of liquid chemical and creates an attachment that is removable only with a force in excess of 40 lbs. The high amount of force prohibits most any person from removing the end cap with tools or through an intentional destructive act. The use of an open aperture allows either the manufacturer or consumer to fill the vessel casing and seal the vessel casing with the end cap 54. The vessel casing side wall 42 is preferably made of a flexible material so as to allow ease of ampoule breakage which results in the production of light. This embodiment would allow ease of removal of the contents after usage, including the frangible broken vials 50 and 52, as well as the spent chemical composition when the vessel casing 40 and the end cap 54 may be reused by placement of new activator and oxalate containers 50 and 52 or for plastic recycling.

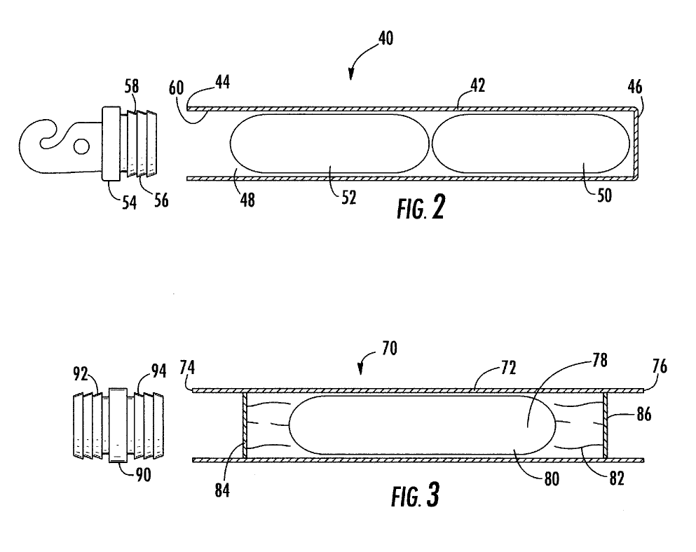

Referring now to FIG. 3, set forth is embodiment depicting a sealed vessel casing 70 formed from a translucent continuous side wall 72, having a first end 74 and second end 76. A cavity 78 is formed between the first and second end wherein an activator 80 and an oxalate 82 may be placed within the cavity. It should be noted that the activator is shown in a frangible ampoule and the activator placed within the cavity, the activator and oxalate can be reversed. In this embodiment the first end includes end wall 84 and the second end 76 includes end wall 86 which creates a sealed cavity even when the end cap(s) are removed. The end walls are recessed from each end 74 & 76 so as to allow receipt of an end cap. The preferred embodiment is to have the end cap with the connector means along an external surface, however, placement of the connector means along an internal surface of the end cap is deemed within the scope of this invention but not shown as it would be redundant and would increase the manufacturing costs necessary to obtain the high gripping format desired to prevent removal of the end cap. In this embodiment end cap 90 is depicted having an upper body insertion end 92 and a lower body insertion end 94. The use of the coupling end cap allows a joining of multiple light sticks that have at least one recessed end wall as depicted by first end 74 and end wall 84, or when used in combination with light sticks have duel recessed end walls as further depicted by second end 76 and end wall 86.

FIG. 4 depicts an end cap 100 having an upper end 102 and a lower end 104. The upper end formed into a conventional hook shape 106 with a pass through aperture 108. The connector means of the lower portion of the body has a full thread 110 which allows threadingly engagement into a vessel casing aperture. Tests have indicated the use of a full thread, without reciprocal threads on the vessel casing aperture, provide an adequate frictional engagement that would resist separation until approximately 22 lbs is applied. The thread allows for ease of installation by hand, as well as removal, but does not provide the most efficient method of manufacturing.

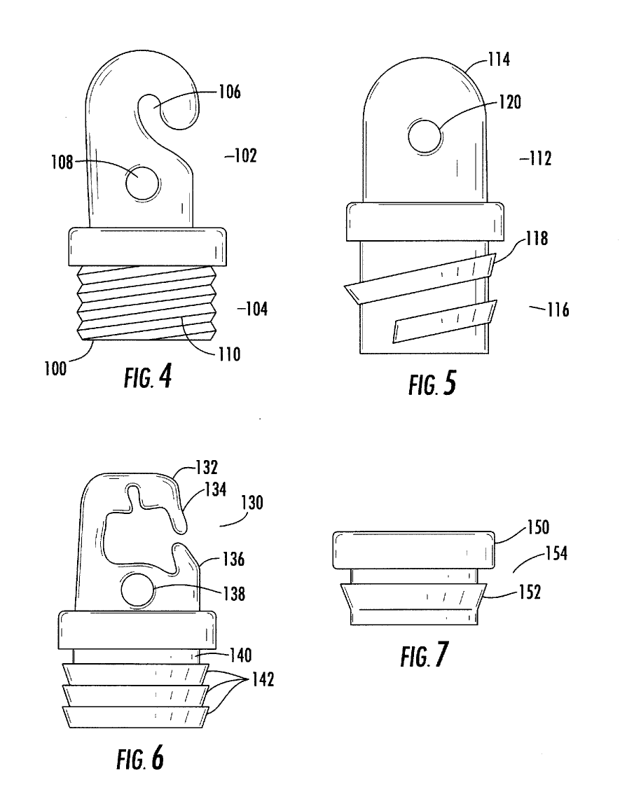

FIG. 5 depicts a split thread end cap 112 having an upper body 114 and lower body 116. The lower body having a split thread 118 which tests have indicated have that a force of approximately 37 lbs is necessary for removal. The split thread had the advantage of a thread/press fit that allows ease of press fit installation and a threaded removal. This embodiment shows an upper portion having a single pass through aperture 120.

FIG. 6 depicts a hook and gate end cap 130 having an upper portion 132 with a hook 134 and gate 136 for use in coupling to various sized objects, as well as pass through aperture 138. The lower portion 140 has multiple barbs 142 which have the benefit of an ease of installation as a press-in end cap with minimal deformation. The multiple barbs provide the highest resistance to removal with testing indicating that a force of over 40 lbs. is necessary to cause removal. The use of multiple barbs is especially beneficial inhibiting the consumer from disengaging the end cap from the vessel casing aperture.

FIG. 7 is a plug drive end cap 150 having a lower portion 152 with a single barb 154. The advantage of the single barb is the lower cost and design in manufacturing, but tests have indicated that a single barb allows a pull out of the end cap at approximately 18 lbs. of force. The use of a single barb is most advantageous in instances where the end cap is plug, thus the consumer does not have any structure to use in pulling of the plug. The tests performed include a spin test to determine if each thread or barb design could hold its own weight and a pull test to determine the failed strength of each insert design as being pulled from the pass through “lanyard” apertures. The use of a light stick having a common body such as that depicted in FIG. 1, FIG. 2, or FIG. 3 allows for simplicity in manufacturing as the lines can be set up for commonality of the vessels, yet the types of end caps can be made virtually unlimited in both shape and materials. For instance, due to the reusability of the end cap, the end cap may be out of plastic, stainless steel, aluminum, or any other material and in particular shape that allows for use in a particular application. Removal of the end cap allows for recycling of the product or even reuse if the consumer chooses to have an unsealed vessel wherein the open aperture would allow removal of spent chemical composition and reinstallation of new chemical composition replacement.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims.

Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims. Variations include different upper portions as well as lower portions. For instance, the upper portion may be a peg, socket, t-shape, and so forth. The lower portion may be of any type attachment including custom made shapes.

What is claimed is:

1. A chemiluminescent lighting device comprising:
a vessel casing formed from a translucent continuous sidewall having a first end and a second end with a cavity formed therebetween, at least one of said first end or said second end defining a vessel casing aperture constructed and arranged to accept insertion of chemiluminescent reactants into said cavity for storage; and
an end cap removably insertable into said vessel casing aperture;
whereby said stored chemiluminescent reactants are available to produce illumination visible through the sidewall of the vessel casing wherein said end cap requiring at least 20 lbs of force to remove after insertion into vessel casing aperture.

2. The chemiluminescent lighting device according to claim 1 wherein said end cap seals said chemiluminescent reactants in said cavity.

3. The chemiluminescent lighting device of claim 1 wherein said vessel casing is flexible.

4. The chemiluminescent lighting device of claim 1 wherein said chemiluminescent reactants are further defined as a first chemical composition placed in a frangible sealed container positionable inside said vessel casing and a second chemical composition placed inside said vessel casing whereby mixing of said first and second chemical compositions produces light.

5. The chemiluminescent lighting device of claim 1 wherein said chemiluminescent reactants are further defined as a first chemical composition placed in a frangible sealed container positionable inside said vessel casing and a second chemical composition placed in a frangible sealed container positionable inside said vessel casing whereby mixing of said first and second chemical compositions produces light.

6. The chemiluminescent lighting device of claim 1 wherein said end cap is further defined as an upper body and a lower body, said upper body having at least one pass through aperture and said lower body having at least one continuous barb formed along an outer surface of said lower body, said lower body insertable into said vessel casing aperture wherein said barb to frictionally engage an inner surface of said vessel casing aperture.

7. The chemiluminescent lighting device of claim 1 wherein said end cap is further defined as an upper body and a lower body, said upper body having at least one pass through aperture and said lower body having at least one thread formed along an outer surface of said lower body, said lower body insertable into said vessel casing aperture wherein said thread to frictionally engage an inner surface of said vessel casing aperture.

8. The chemiluminescent lighting device of claim 1 wherein said end cap is further defined as an upper body and a lower body, said upper body having at least one open aperture and said lower body having at least one continuous barb formed along an outer surface of said lower body, said lower body insertable into said vessel casing aperture wherein said barb to frictionally engage an inner surface of said vessel casing aperture.

9. The chemiluminescent lighting device of claim 1 wherein said end cap is further defined as an upper body and a lower body, said upper body having at least one open aperture and said lower body having at least one thread formed along an outer surface of said lower body, said lower body insertable into said vessel casing aperture wherein said thread to frictionally engage an inner surface of said vessel casing aperture.

10. The chemiluminescent lighting device of claim 1 wherein said end cap is further defined as an upper body and a lower body, said upper body having at least one coupling aperture and said lower body having at least one continuous barb formed along an outer surface of said lower body, said lower body insertable into said vessel casing aperture wherein said barb to frictionally engage an inner surface of said vessel casing aperture.

11. The chemiluminescent lighting device according to claim 1 wherein said vessel casing aperture includes an end wall that seals said chemiluminescent reactants in said cavity.

12. A chemiluminescent lighting device comprising:
a vessel casing formed from a translucent continuous sidewall having a first end and a second end with a cavity formed therebetween, at least one of said first end or said second end defining a vessel casing aperture constructed and arranged to accept insertion of chemiluminescent reactants into said cavity for storage;
an end wall sealing said chemiluminescent reactants in said cavity; and
an end cap removably insertable into a portion of said vessel casing aperture;
whereby said stored chemiluminescent reactants are available to produce illumination visible through the sidewall of the vessel casing wherein said end cap is available to securing said lighting device to another object.

13. The chemiluminescent lighting device according to claim 12 wherein said end cap requires at least 15 lbs of force to remove after insertion into a portion of said vessel casing aperture.

14. The chemiluminescent lighting device of claim 12 wherein said vessel casing is flexible.

15. The chemiluminescent lighting device of claim 12 wherein said end cap is further defined as an upper body and a lower body, said upper body having at least one pass through aperture and said lower body having at least one continuous barb formed along an outer surface of said lower body, said lower body insertable into said vessel casing aperture wherein said barb to frictionally engage an inner surface of said vessel casing aperture.

16. The chemiluminescent lighting device of claim 12 wherein said end cap is further defined as an upper body and a lower body, said upper body having at least one pass through aperture and said lower body having at least one thread formed along an outer surface of said lower body, said lower body insertable into said vessel casing aperture wherein said thread to frictionally engage an inner surface of said vessel casing aperture.

17. The chemiluminescent lighting device of claim 12 wherein said end cap is further defined as an upper body and a lower body, said upper body having at least one open aperture and said lower body having at least one continuous barb formed along an outer surface of said lower body, said lower body insertable into said vessel casing aperture wherein said barb to frictionally engage an inner surface of said vessel casing aperture.

18. The chemiluminescent lighting device of claim 12 wherein said end cap is further defined as an upper body and a lower body, said upper body having at least one open aperture and said lower body having at least one thread formed along an outer surface of said lower body, said lower body insertable into said vessel casing aperture wherein said thread to frictionally engage an inner surface of said vessel casing aperture.

19. A chemiluminescent lighting device kit comprising:
a vessel casing formed from a translucent continuous sidewall having a first end and a second end with a cavity formed therebetween, at least one of said first end or said second end defining a vessel casing aperture constructed and arranged to accept insertion of chemiluminescent reactants into said cavity for storage;
at least one end cap defined by an upper body having a connector means and a lower body having a coupling means, said lower body releasably insertable into said vessel casing aperture.

20. The chemiluminescent lighting device kit according to claim 19 wherein said end cap seals said chemiluminescent reactants in said cavity.

21. The chemiluminescent lighting device kit of claim 19 wherein said vessel casing is flexible.

22. The chemiluminescent lighting device kit according to claim 19 wherein said vessel casing aperture includes an end wall that seals said chemiluminescent reactants in said cavity.
